(19) United States
(12) Patent Application Publication
(10) Pub. No.: US 2024/0096239 A1
(43) Pub. Date: Mar. 21, 2024

(54) REMOTE BREATHING AND VOCALIZATION SIMULATING DEVICE

(71) Applicant: Sony Group Corporation, Tokyo (JP)

(72) Inventors: Anja PFLUG, Stuttgart (DE); Gonzalo BAILADOR DEL POZO, Stuttgart (DE)

(73) Assignee: Sony Group Corporation, Tokyo (JP)

(21) Appl. No.: 18/275,227

(22) PCT Filed: Mar. 9, 2022
(86) PCT No.: PCT/EP2022/056108

§ 371 Date: Aug. 1, 2023

(30) Foreign Application Priority Data
Mar. 22, 2021 (EP) 21164016.4

(51) Int. Cl. G09B 23/32

(52) U.S. Cl. CPC G09B 23/32

(57) ABSTRACT

A body simulator is disclosed. The body simulator includes a receiver configured to receive a signal based on sensor data including vocalization data from a subject, and a body which includes a breathing simulator and a vocalization simulator. The breathing simulator simulates the breathing of a subject. The vocalization simulator can simulate vocalization, audio, speaking, and/or vibrations associated therewith. The body simulator is configured to modulate the simulated breathing based on vocalization data.

### FIELD

The present disclosure relates to the simulation of a living body.

### BACKGROUND

Body simulation devices can involve visual, audio, and haptic components. Body simulation devices may be used to simulate the presence of another person. For example, body simulation devices have been used for children, for example in neonatal care, to simulate the presence of a parent. Adults may also use body simulators, e.g. when couples are separated, to bridge the physical distance.

### SUMMARY

In view of the technical challenges in simulating a living body, herein is disclosed a body simulator as defined in appended independent claim 1, a device as defined in appended independent claim 13, a system for simulating the body of a subject as defined in independent claim 14, and a method for simulating a body as defined in appended claim 15. Further advantages can be provided by the subject matter defined in the dependent claims.

A body simulator is disclosed herein. The body simulator includes a receiver configured to receive a signal based on sensor data including vocalization data from a subject, and a body which includes a breathing simulator and a vocalization simulator. The breathing simulator simulates the breathing of a subject. The vocalization simulator can simulate vocalization, speaking, and/or vibrations associated therewith. Simulation of vocalization and/or speech may include vibrations, audio, speech, and/or speech motion, for example. The body simulator can be configured to modulate the simulated breathing based on the vocalization data.

A device, including at least one sensor for acquiring breathing data and vocalization data, is disclosed herein. The device includes a transmitter for transmitting a signal including a breathing component and a vocalization component. The breathing component is based on the breathing data and can be modulated based on the vocalization data.

A system for simulating a body of a subject is disclosed herein. The system includes at least one sensor for acquiring vocalization data, a transmitter for transmitting a signal based on the vocalization data, and a body simulator. The body simulator includes a receiver configured to receive the signal, and a breathing simulator configured to simulate the breathing of the subject. The system is configured to modulate the simulated breathing based on the vocalization data.

A method for simulating a body is disclosed herein. The method includes determining vocalization data from at least one sensor; transmitting a signal based on the vocalization data; receiving the signal at a body simulator; simulating breathing; simulating vocalization based on the vocalization data; and modulating the simulated breathing based on the vocalization data.

### BRIEF DESCRIPTION OF THE FIGURES

Some examples of apparatuses and/or methods will be described in the following by way of example, and with reference to the accompanying figures, in which:

FIG. 1 illustrates a body simulator, according to embodiments described herein;

FIG. 2 illustrates a device for use with a body simulator, according to embodiments described herein;

FIG. 3 illustrates a method 300 for simulating a body, according to embodiments described herein; and

FIG. 4 illustrates a system including a body simulator, according to embodiments described herein.

### DETAILED DESCRIPTION

Various examples will now be described more fully with reference to the accompanying drawings in which some examples are illustrated. The figures are not necessarily to scale.

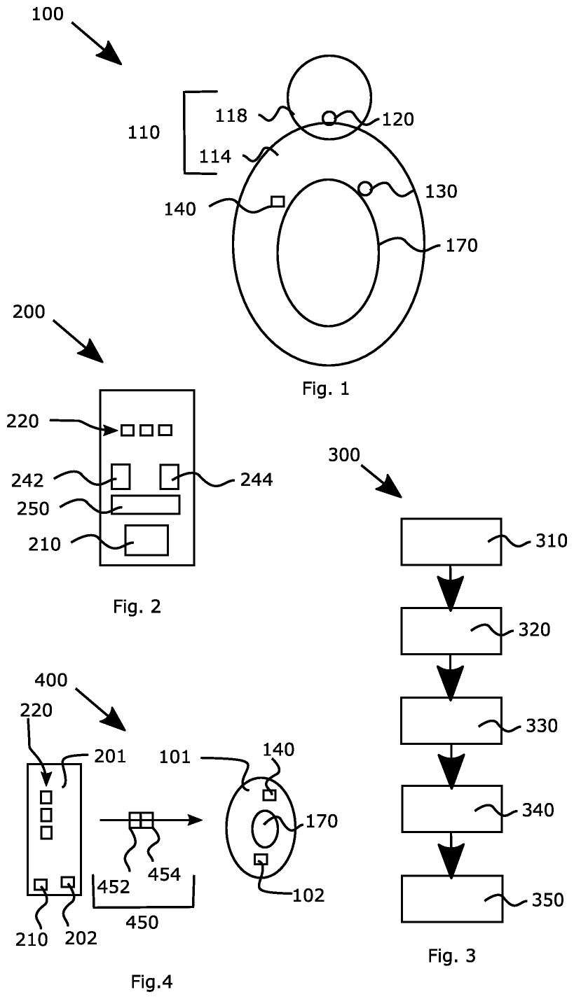

FIG. 1 illustrates a body simulator 100. The body simulator 100 includes a body 110 which may include a chest region 114 and head and neck region 118. The body 110 may be a pillow, toy, and/or a stuffed animal, for example. A soft and/or plush body simulator 100 is possible. The body simulator 100 may have a fabric outer layer and/or a compliant outer layer. The body 110 includes a breathing simulator 170 which may include hydraulics and/or pneumatics for the simulation of breathing, particularly the motions of breathing, such as by periodically expanding and relaxing the chest region 114. The body simulator can include a receiver 140 for receiving a signal which is based on sensor data, such as sensor data from a subject. Sensor data may include vocalization data, pressure sensor data, inertial sensor data, heartbeat data, and/or breathing data.

The body simulator 100 may also include a vocalization simulator 120. The vocalization simulator 120 may simulate vocalizations, speech, and/or vibrations associated therewith, such as speech motion. The vocalization simulator 120 may produce vibrations. The vocalization simulator 120 may haptically simulate the vocalizations, voice, and/or speech of the subject, and/or the vibrations associated therewith. The simulation of a voice may include audio and/or vibrations, e.g. to haptically simulate vibrations of a voice box. The vocalization simulator 120 of the body simulator 100 may produce audio based on the vocalization data and/or speech data of the subject.

FIG. 2 illustrates a device 200 for use with a body simulator 100. For example, the device 200 is used by a subject, e.g. a user who is remote to the body simulator 100. Another user may be proximate to the body simulator 100, e.g. a local user. The device 200 may be communicatively coupled directly or indirectly to the body simulator 100. The device may include a transmitter 210. The sensors 220 may determine and/or acquire data of breathing, vocalization such as speech and/or speech motion. The device 200 may have a plurality of sensors 220, such as a first sensor for breathing data 242 and a second sensor for vocalization data 244.

The device 200 may be a wearable device, such as a wristband. At least some of the sensor(s) 220 of the device 200 may be integrated with a wearable device.

The sensors 220 of the device 200, as shown in FIG. 2, may include camera(s), microphone(s), and/or sensors for sensing vital parameters. Sensors 220 may include any combination of a blood oxygenation sensor, heartbeat sensor, pulse sensor, pulse oximetry sensor, oxygen saturation sensor, and inertial measurement sensor, laser Doppler flowmetry (LDF) sensor, and/or photoplethysmography (PPG) sensor, for example. The sensor(s) may determine and/or acquire breathing data, vocalization data, and/or heartbeat data.

The simulated breathing of the body simulator 100 may simulate the breathing of the subject. A local user may interact with the body simulator 100. The physical presence of the subject, e.g. at least some attributes of physical presence such as breathing motion, may be simulated by the body simulator 100, e.g. for the local user.

The simulated breathing can be modulated based on vocalization data 244. The body simulator 100 can modulate the simulated breathing based on the vocalization data 244. The modulation can be intermittent, such as coinciding with the vocalization data 244, such as according to the determination of an onset of vocalization, utterance, and/or speech, and/or the determination of the end of a vocalization, speech, and/or utterance.

The vocalization simulator 120 of the body simulator 100 may be located in a head and neck region 118 of the body 110 of the body simulator 100. The breathing simulator 170 may be located in the chest region 114 of the body 110 of the body simulator 100. The body simulator 100 may include a heartbeat simulator 130, which may be located in the chest region 114.

FIG. 3 illustrates a method 300 for simulating a body. The method includes determining 310 vocalization data from a sensor; transmitting 320 a signal based on the vocalization data; receiving 330 the signal at a body simulator; simulating breathing 340; and modulating 350 the simulated breathing based on the vocalization data. The method may also include simulating vocalization and/or speaking such as by simulating vocalization, vibrations due to vocalization, speech motions, and/or speech. The simulated vocalization can be based on vocalization data, e.g. solely based on the vocalization data. A heartbeat signal may also be transmitted to the body simulator 100, e.g. a component of the signal received at the body simulator 100 may be based on heartbeat sensor data. The heartbeat of the subject can be simulated at the body simulator 100.

The simulated breathing of the breathing simulator 170 may be modulated by vocalization data 244 from the subject. It is possible that vocalization data may be absent, e.g. temporarily. When vocalization data is not being actively used for modulation, e.g. if vocalization data is not present, and/or when the subject is silent, then the simulated breathing can be based on other sensors.

The method may also include reproducing and/or simulating the audio of the subject at the body simulator, e.g. based on the vocalization data. The method may also include simulating the heartbeat of the subject at the body simulator, such as with a heartbeat simulator of the body simulator.

For example, the simulated breathing, at the body simulator 100, of the subject may be generated in real-time. The simulated vocalization may also be generated in real-time. Such simulation allows for a more realistic simulation and may allow for various modes of biosynchronization of the user(s). For example, it can be possible that the breathing and/or heartrate may naturally synchronize when in the presence of another. It is desirable to enable real-time communication and/or synchronization between a remote user and local user.

FIG. 4 illustrates a system, according to embodiments described herein. A system 400 for simulating a body of a subject can include at least one sensor 220 for acquiring vocalization data; a transmitter 210 for transmitting a signal 450 based on the vocalization data; and a body simulator 101. The body simulator 101 can include a receiver 140 configured to receive the signal 450, and a breathing simulator 170 configured to simulate the breathing of the subject. The system 400 can be configured to modulate the simulated breathing based on the vocalization data. The sensor(s) can also acquire breathing data, and the signal 450 can also be based on the breathing data. The signal 450 may include more than one component, e.g. a heartbeat component, a breathing component, and/or a vocalization component.

The body simulator 101 of the system 400 can be communicatively coupled to a device 201 (e.g. a transmitter of the device). The device 201 may include at least one of the sensors 220. The body simulator 101 of the system 400 may be as described elsewhere herein, such as with reference to FIG. 1. The device 201 may be described as elsewhere herein, such as with reference to FIG. 2.

The device 201 may transmit a signal 450 including a breathing component 452, which can be based on the breathing data 242. The signal 450 may be received by the body simulator 100, directly or indirectly. For example, the signal may be communicatively coupled to the body simulator directly through wireless (e.g. Bluetooth), or through a communications network (e.g. the internet).

Referring to FIG. 4, the signal 450 transmitted by the device 201 (e.g. the device 200 as shown in FIG. 2) may include a vocalization component 454. The breathing component 452 of the transmission can be based on the breathing data 242, and can be modulated based on the vocalization data 244 (e.g. by at least one processor 202, 102 which may be at the device 201, the body simulator 101, or at an intermediary, such as in the cloud).

It is also possible that one or more sensors 220 are separate from the wearable device, e.g. cameras, microphones, and/or sensors for determining vocalization and/or breathing. Sensors can be communicatively coupled directly or indirectly to the body simulator 100, 101, e.g. through a transmitter which can be part of the device.

Referring also to FIG. 2, a processor(s) 250 of the device 200 may modify and/or modulate the breathing data 242 and/or breathing component 452 of the signal 450. Alternatively/additionally, the modulation of the simulated breathing may be done at the body simulator 100 and/or elsewhere, such as by at least one processor, e.g. in the communications network, the cloud, and/or at the body simulator 101. The body simulator 101 may include a processor(s) 102 for determining modulation of the simulated breathing.

The body simulator 100 and device 200 may make up at least part of a system 400 for simulating the body of a subject (e.g. simulating the body of the subject, e.g. the user who may be remote to the body simulator 100, and from whom the sensor data may be determined/acquired). A system 400 may include any body simulator 100 as described herein in combination with any device 200 described herein, such as those which determine sensor data including breathing and/or vocalization data, as described herein.

The simulated breathing can be based on a breath component 452 of the signal 450. The simulated vocalization can be based on a vocalization component 454 of the signal 450. The simulated breathing can also be based on the vocalization component 454 of the signal 450. For example, the simulated breathing is modulated based on the vocalization component 454 and/or the vocalization data 244.

The determination of the simulated breathing may be through the use of various possible data processing methods which may process the sensor data, e.g. the breathing data 242 and/or the vocalization data 244. For example, when signal:noise is high enough for accurate real-time determination of the breathing phase and/or frequency of the subject by the sensor(s) 220, the simulated breathing may be directly determined in real-time by the processor(s) 102, 202 of the device 200, body simulator 100, and/or system 400 based directly on the sensor data.

Scaling factors may be used which can link the amplitude of the sensor data input (e.g. a periodic breathing sensor signal) with a control signal(s) transmitted to the breathing simulator(s) 170. For example, the simulated breathing may be accomplished by scaling and/or offsetting a periodic sensor signal (e.g. sensor data that is acquired over time) and transmitting the scaled signal to control a pneumatic and/or hydraulic breathing simulator 170). The simulated breathing, and/or the control signal therefor, may be processed with more or less sophistication, such as by including filters such as noise filters, low pass filters, and/or smoothing, for example.

The breathing simulation may be determined by algorithms, including machine learning algorithms. For example, the breathing simulation signal may be determined after assessment of multiple cycles of the breathing of the subject. For example, one or more sensor inputs, e.g. breathing data 242, which may include LDF and/or PPG, may be processed to determine the breathing phase, rate, frequency, and/or the breathing component 452 of the signal 450. There may be some latency in determining the breathing component 452 of the signal 450, e.g. due to data collection over a time period. Such latent periods can increase certainty in determination of the breathing component 452, particularly the phase thereof, particularly when breathing is regular and/or having a periodic component. Latency may also complicate the synchronization of the breathing component 452 to the subject's actual breathing pattern, particularly when perturbations to usual breathing patterns occur. Such perturbations include, for example, speech and/or other vocalizations of the subject. Embodiments described herein may address problems associated with simulating breathing at a body simulator when perturbations such as vocalizations and/or speech occur.

The body simulator 100, device 200, and/or system 400 may intermittently synchronize the simulated breathing. For example, the synchronization may be made with respect to the simulated vocalization, the breathing data 242, and/or the vocalization data 244. Simulation of a body's breathing, vocalization, and/or speaking may be more realistic when there is increased coordination and/or correlation between the simulated vocalization and breathing. Intermittent synchronization of the simulated breathing to at least one of the vocalization data 244 or the simulated vocalization is particularly contemplated.

For example, the simulated breathing may include a periodic component, such as a sinusoidal component. The periodic component may be determined based on the breathing data 242. The breathing component 452 of the signal 450 which can be used to simulate the breathing at the body simulator 100 can include the periodic component.

The body simulator 100, device 200, and/or system 400 can intermittently synchronize the simulated breathing and the simulated vocalization and/or vocalization data 244.

There may be modulation of the periodic component of the simulated breathing. The simulated breathing may include the periodic component and a modulation, which may be a variable modulation.

For example, subsequent to the determination of the periodic component of the simulated breathing, the simulated breathing can be intermittently synchronized, modulated, and/or adjusted. The vocalization component 454 of the signal 450 and/or the vocalization data 244 may be used to determine the intermittent synchronization, modulation, and/or adjustment. Alternatively/additionally, the signal 450 may be intermittently synchronized and/or modulated based on the vocalization data 244. Intermittent synchronization and/or modulation may occur at the body simulator 100, the device 200, and/or in the system 400, e.g. in the cloud.

For example, a processor(s) at the body simulator 100, the device 200, and/or the system 400 can be used. For example, processor(s) may cause modulation of the breathing simulation, such as by modulating the breathing component 452 of the signal 450. Processor(s) in the cloud may be advantageous for having greater computational power, and may have access to more data for more effective machine learning algorithms. Local processor(s), particularly in the device 200 and/or body simulator 100, may be advantageous for having low latency, particularly when the device 200 and body simulator 100 are directly communicatively coupled.

The modulation of the breathing simulation may be based on the vocalization component 454 of the signal 450. The modulation may be at least one of: a phase shift, a delay, a positive pulse superimposed on the simulated breathing, a negative pulse superimposed on the simulated breathing, an increase in amplitude, a decrease in amplitude, an increase in frequency, or a decrease in frequency.

For example, if whispering by the subject is detected (e.g. by a vocalization sensor, sound sensor, and/or microphone), the inhalation phase of breathing by the subject may be delayed and/or the exhalation phase of the subject extended. A phase delay, e.g. a phase delay of the simulated breathing, may improve the real-time emulation of the breathing of the subject at the body simulator 100, particularly when speech and/or vocalization is detected and/or determined.

In another example, the sensor(s) 220 detects the subject vocalizing and/or speaking for a duration, for example from 3 to 5 seconds. The simulated breathing may be modulated by having the exhalation phase coincide with the duration (such as by extending the exhalation phase to last until the end of the duration). Alternatively/additionally, simulated breathing may be modulated by a inhalation phase of breathing which is subsequent to an utterance. A subsequent inhalation may also be modulated in the sense that the inhalation may be deeper than a previous periodic inhalation, e.g. due to preceding vocalization and/or speech.

With these examples, it is to be appreciated how vocalizations such as speech may cause changes in breathing. An utterance of a few seconds, as an example, may result in modulation of the simulated breathing. It can be advantageous to modulate the simulated breathing based on data from a vocalization sensor(s), such as when processor(s) and/or sensor(s), which may exhibit latency or lag, are used. Sensors having latency (such as laser Doppler flowmetry (LDF) sensors and/or photoplethysmography (PPG) sensors) for acquiring breathing data may be minimally invasive, which is desirable. Such sensors can be combined with vocalization sensors (which may have low latency, such as a microphone) for determining the modulation of as periodic component of the simulated breathing, particularly when the periodic component is determined principally at least by the sensors having latency. The latency described herein may be attributable to the sensor data and/or the processing of the sensor data. For example, processing of laser Doppler flowmetry (LDF) sensor and/or photoplethysmography (PPG) sensor data may be slower than data processing of microphone data.

A modulation of the simulated breathing can be any one or more of: a frequency shift, a phase shift, a delay, a positive pulse superimposed on the simulated breathing, a negative pulse superimposed on the simulated breathing, an increase in amplitude, or a decrease in amplitude. It is possible that the modulation occurs in pairs of perturbations, such as a temporary phase shift (e.g. a phase shift followed by a second phase shift that cancels the first). In another example, there is a 1-2 second decrease in frequency, possibly triggered by determination of a vocalization, followed by a return to the initial frequency of simulated breathing.

The modulation may be based on the detection of a speech break, such as an end of an utterance. An utterance can be defined as an uninterrupted chain of spoken language, such as a linguistic utterance. Alternatively/additionally, the modulation can be based on the detection of the beginning of a vocalization or speech, e.g. such as the beginning of an utterance. It is also possible that the modulation depends on a prediction of a vocalization, and/or the prediction of the length of a vocalization, e.g. once the vocalization has begun.

It is also contemplated to use machine learning, e.g. a machine learning algorithm, to determine the simulated breathing and/or modulation thereof. For example, the fusion of data from the sensor(s) can be used to determine the simulated breathing, e.g. periodicity, amplitude, phase, and/or the modulations (such as frequency shifts, phase shifts, delays, superimposed pulses, and/or changes in amplitude). The sensor data used for machine learning can include the breathing data 242, the vocalization data 244, and/or the signal provided to the breathing simulator.

Fusion of multiple signals and/or sensor data can extract breathing rate and other breathing related parameters such as phase, amplitude and/or periodic form (e.g. a sinusoidal periodic form or a combination of multiple sinusoidal periodic forms). The signals and/or data can come from the device 200, such as a wristband (which may include sensors for LDF and/or PPG). The data can be processed and/or combined with analytics on the vocalization data, speech data, and/or audio data. The processor(s) of the device 200, the body simulator 100, and/or the system 400 may use speech analysis, such as speech break prediction (and/or vocalization break prediction) to model and/or predict breathing, e.g. patterns and/or forms of breathing which can be simulated. Alternatively/additionally, speech recognition can be utilized to determine the modulations applied to the simulated breathing. For example, particular phrases may be correlated with certain breathing patterns.

Machine learning can refer to algorithms and/or statistical models that computer systems may use to perform tasks such as simulate breathing. Machine learning may possibly forgo the use of particularized instructions, instead utilizing models and inference. For example, in machine-learning, instead of a rule-based transformation of data (e.g. transforming sensor data into control data for the breathing simulator), a transformation of data may be used that is inferred from an analysis of historical and/or training data. For example, sensor data may be analyzed using a machine-learning model or using a machine-learning algorithm.

In order for the machine-learning model to analyze the sensor data, the machine-learning model may be trained using training data (e.g. vocalization data, speech data, and/or breathing data of relatively low resolution and/or high latency) as input and training information (e.g. breathing data at high resolution and/or low latency as output). By training the machine-learning model with a large dataset of sensor data as training content information, the machine-learning model “learns” to recognize the sensor data, so the simulated breathing can be determined even when data which is not directly included in the training data can be utilized and/or recognized using the machine-learning model. The same principle may be used for other kinds of sensor data as well. By training a machine-learning model using training sensor data and a desired output (e.g. an output that is based on high resolution, low latency breathing sensor data that might not be available during the operation of the body simulator), the machine-learning model “learns” a transformation between the sensor data and the output, which can be used to provide an output based on non-training sensor data provided to the machine-learning model.

For example, high resolution and/or low latency breathing sensor data can be used for training. The high resolution and/or low latency breathing sensor data may be from, for example, contact sensors, piezoelectric sensors, flow sensors, LIDAR sensors, and/or time-of-flight sensors. Naturally, such sensors can be used in the body simulator 100 as well. However, such sensors may be undesirable due to cost and/or invasiveness. Nevertheless, such sensors may be used to train the model to utilize the data from less expensive and/or less invasive sensors, such as microphones, blood oxygenation sensors, heartbeat sensors, pulse sensors, pulse oximetry sensors, oxygen saturation sensors, cameras, LDF sensors, PPG sensors, and inertial measurement sensors.

Machine-learning models can be trained using training input data. A training method called “supervised learning” can be used. In supervised learning, the machine-learning model can be trained using a plurality of training samples, wherein each sample may include a plurality of input data values, and a plurality of desired output values, i.e. each training sample is associated with a desired output value. By specifying both training samples and desired output values, the machine-learning model “learns” which output value to provide based on an input sample that is similar to the samples provided during the training.

Semi-supervised learning may be used. In semi-supervised learning, some of the training samples may lack a corresponding desired output value. Supervised learning may be based on a supervised learning algorithm, e.g. a classification algorithm, a regression algorithm or a similarity learning algorithm. Classification algorithms may be used when the outputs are restricted to a limited set of values, i.e. the input is classified to one of the limited set of values. Regression algorithms may be used when the outputs may have any numerical value (within a range). Similarity learning algorithms are similar to both classification and regression algorithms. Similarity learning algorithms may be based on learning from examples using a similarity function that measures how similar or related two objects, e.g. sets of sensor data, are.

Apart from supervised or semi-supervised learning, unsupervised learning may be used to train the machine-learning model. In unsupervised learning, (only) input data might be supplied, and an unsupervised learning algorithm may be used to find structure in the input data, e.g. by grouping or clustering the input data, finding commonalities in the data. Clustering is the assignment of input data comprising a plurality of input values into subsets (clusters) so that input values within the same cluster are similar according to one or more (pre-defined) similarity criteria, while being dissimilar to input values that are included in other clusters.

Reinforcement learning is a third group of machine-learning algorithms. In other words, reinforcement learning may be used to train the machine-learning model. In reinforcement learning, one or more software actors (called “software agents”) are trained to take actions in an environment. Based on the taken actions, a reward is calculated. Reinforcement learning is based on training the one or more software agents to choose the actions such that the cumulative reward is increased, leading to software agents that become better at the task they are given (as evidenced by increasing rewards).

Furthermore, some techniques may be applied to some of the machine-learning algorithms. For example, feature learning may be used. In other words, the machine-learning model may at least partially be trained using feature learning, and/or the machine-learning algorithm may comprise a feature learning component. Feature learning algorithms, which may be called representation learning algorithms, may preserve the information in their input, but also transform it in a way that makes it useful, often as a pre-processing step before performing classification or predictions. Feature learning may be based on principal components analysis or cluster analysis, for example.

In some examples, anomaly detection (i.e. outlier detection) may be used, which is aimed at providing an identification of input values that raise suspicions by differing significantly from the majority of input or training data. In other words, the machine-learning model may at least partially be trained using anomaly detection, and/or the machine-learning algorithm may comprise an anomaly detection component.

In some examples, the machine-learning algorithm may use a decision tree as a predictive model. In other words, the machine-learning model may be based on a decision tree. In a decision tree, observations about an item (e.g. a set of sensor data) may be represented by the branches of the decision tree, and an output value corresponding to the item (e.g. the simulated breathing output based on high resolution, low latency data) may be represented by the leaves of the decision tree. Decision trees may support both discrete values and continuous values as output values. If discrete values are used, the decision tree may be denoted a classification tree, if continuous values are used, the decision tree may be denoted a regression tree.

Association rules are a further technique that may be used in machine-learning algorithms. In other words, the machine-learning model may be based on one or more association rules. Association rules can be created by identifying relationships between variables in large amounts of data. The machine-learning algorithm may identify and/or utilize one or more relational rules that represent the knowledge that is derived from the data. The rules may e.g. be used to store, manipulate or apply the knowledge.

Machine-learning algorithms are usually based on a machine-learning model. The term “machine-learning algorithm” may denote a set of instructions that may be used to create, train, or use a machine-learning model. The term “machine-learning model” may denote a data structure and/or set of rules that represents the learned knowledge, e.g. based on the training performed by the machine-learning algorithm. In embodiments, the usage of a machine-learning algorithm may imply the usage of an underlying machine-learning model (or of a plurality of underlying machine-learning models). The usage of a machine-learning model may imply that the machine-learning model and/or the data structure/set of rules that is the machine-learning model is trained by a machine-learning algorithm.

For example, the machine-learning model may be an artificial neural network (ANN). ANNs are systems that are inspired by biological neural networks, such as can be found in a brain. ANNs comprise a plurality of interconnected nodes and a plurality of connections, so-called edges, between the nodes. There are usually three types of nodes, input nodes that receive input values, hidden nodes that are (only) connected to other nodes, and output nodes that provide output values. Each node may represent an artificial neuron. Each edge may transmit information, from one node to another. The output of a node may be defined as a (non-linear) function of the sum of its inputs. The inputs of a node may be used in the function based on a “weight” of the edge or of the node that provides the input. The weight of nodes and/or of edges may be adjusted in the learning process. In other words, the training of an artificial neural network may comprise adjusting the weights of the nodes and/or edges of the artificial neural network, i.e. to achieve a desired output for a given input. In at least some embodiments, the machine-learning model may be deep neural network, e.g. a neural network comprising one or more layers of hidden nodes (i.e. hidden layers), prefer-ably a plurality of layers of hidden nodes.

Alternatively, the machine-learning model may be a support vector machine. Support vector machines (i.e. support vector networks) are supervised learning models with associated learning algorithms that may be used to analyze data, e.g. in classification or regression analysis. Support vector machines may be trained by providing an input with a plurality of training input values that belong to one of two categories. The support vector machine may be trained to assign a new input value to one of the two categories. Alternatively, the machine-learning model may be a Bayesian network, which is a probabilistic directed acyclic graphical model. A Bayesian network may represent a set of random variables and their conditional dependencies using a directed acyclic graph. Alternatively, the machine-learning model may be based on a genetic algorithm, which is a search algorithm and heuristic technique that mimics the process of natural selection.

Herein are disclosed technologies to address problems related to separation of couples, which may occur for example due to corona lockdown for significant durations. Video and/or audio communication may be part of the solutions. Herein, the experience of feeling the other person, for example, when sleeping side-by-side can be simulated with it possibly the synchronization of vital parameters which can take place automatically (via inter-subject synchronization).

It is possible to measure heartbeat and respiration in real-time using sensors like wristbands, smart mattresses, pressure sensors and inertial measurement sensors (which may also transfer motion or haptic senses such as hugging), cameras, and microphones (or any other sensor, particularly those capable of measuring vital parameters such as respiration).

Herein, processing may be done to sensor data. Processing may extract features of respiration and heart rate and possibly convert the data into signals and/or vectors which can be transmitted. Processing may occur at the site of the sensing (e.g. at the site of a subject), at the site of the body simulator 100 (e.g. by at least one processor at the body simulator 100), or between (such as in the cloud). Alternatively, sensed movement patterns, such as may be encoded as filtered signals, can be transmitted from the subject to the body simulator 100, possibly directly. A combination signal which includes audio (e.g. a speech signal) can be possible, e.g. by including vocalization data, e.g. speech motion, together with the respiration signal. If respiration rate is used, machine learning algorithms can enable an adaptation to speech modulated breathing.

Herein, communicative coupling between the subject and the body simulator can be through any connection network (e.g. bluetooth, internet).

The body simulator 100 can be include soft material. The body simulator 100 may be like a pillow. The body simulator 100 can be equipped with pneumatic, hydraulic, audio, and/or vibration modules in order to mimic the respiration, heartbeat, and/or vocalization. Additionally, the body simulator 100 can be formed in a human shape with arms to allow hugging or other motions. The body simulator 100 can also be a robot, a toy, a teddy bear, or any kind of object which feels more connecting when presenting breathing, vocalization, and/or heartbeats.

Proposed uses can include:
Couples who are separated and sleeping apart;
People under quarantine which are not allowed direct contact;
If somebody is not able to interact (coma, locked in syndrome, ALS patients, or other restrictions);
Parents separated from their kids (refugees, disease, school vacation, babysitting)
Virtual or augmented reality settings;
Connecting couples used to sleeping in different rooms;
For singles to experience parameters from other people; and/or
For people who lost their partner.

Note that the present technology can also be configured as described below.
1. A body simulator, comprising a receiver configured to receive a signal based on sensor data including vocalization data from a subject; and a body which includes: a breathing simulator configured to simulate the breathing of the subject and a vocalization simulator configured to simulate the vocalization of the subject. The body simulator is configured to modulate the simulated breathing based on the vocalization data.
2. The body simulator of (1), wherein the body simulator is configured to intermittently synchronize the simulated breathing and the simulated vocalization.
3. The body simulator of (1) or (2), wherein the simulated breathing is based on a breath component of the signal, and the simulated breathing is based on a vocalization component of the signal.
4. The body simulator of any one of (1) to (3), wherein the body simulator is configured such that the simulated breathing of the subject is generated in real-time, and the simulated vocalization of the subject is generated in real-time.
5. The body simulator of any one of (1) to (4), wherein the body simulator is configured such that the simulated breathing includes a periodic component and a modulation.
6. The body simulator of any one of (1) to (5), wherein the body simulator is configured such that the modulation is based on a vocalization component of the received signal.
7. The body simulator of any one of (1) to (6), wherein the body simulator is configured such that the modulation is an intermittent modulation.
8. The body simulator of any one of (1) to (7), wherein the body simulator is configured such that the modulation is at least one of: a phase shift, a delay, a positive pulse superimposed on the simulated breathing, a negative pulse superimposed on the simulated breathing, an increase in amplitude, or a decrease in amplitude.
9. The body simulator of any one of (1) to (8), wherein the body simulator is configured such that the modulation is determined by a machine learning algorithm.
10. The body simulator of any one of (1) to (9), wherein the body simulator is configured such that the simulated breathing is determined by the machine learning algorithm.
11. The body simulator of (10), wherein the machine learning algorithm is configured to predict a beginning of an utterance or a speech break.
12. The body simulator of any one of (1) to (11), wherein the body includes a chest region and a head and neck region. The breathing simulator is at the chest region, and the vocalization simulator is at the head and neck region.
13. A device, comprising at least one sensor for acquiring breathing data and vocalization data, a transmitter for transmitting a signal including a breathing component and a vocalization component. The breathing component is based on the breathing data and is modulated based on the vocalization data.
14. A system for simulating a body of a subject, comprising: at least one sensor for acquiring vocalization data; a transmitter for transmitting a signal based on the vocalization data; and a body simulator. The body simulator comprises: a receiver configured to receive the signal, and a breathing simulator configured to simulate the breathing of the subject. The system is configured to modulate the simulated breathing based on the vocalization data.
15. A method for simulating a body, comprising: determining vocalization data from a sensor; transmitting a signal based on the vocalization data; receiving the signal at a body simulator; simulating breathing; simulating vocalization based on the vocalization data; and modulating the simulated breathing based on the vocalization data.

The aspects and features mentioned and described together with one or more of the previously detailed examples and figures, may as well be combined with one or more of the other examples in order to replace a like feature of the other example or in order to additionally introduce the feature to the other example.

Herein, a block diagram, flow chart, a flow diagram, a state transition diagram, a pseudo code, and the like may represent various processes, operations or steps, which may, for instance, be substantially represented in transitory and/or non-transitory machine readable medium (e.g. a floppy disc, a DVD, a Blu-Ray, a CD, a ROM, a PROM, and EPROM, an EEPROM or a FLASH memory) and executable by a processor or a programmable hardware, whether or not such processor or a programmable hardware is explicitly shown. Methods disclosed in the specification or in the claims may be implemented by a device having means for performing each of the respective acts of these methods.

A non-transitory computer-readable medium computer program may have a program code for, when executed on a processor, causing the execution of any of the methods described herein.

It is to be understood that the disclosure of multiple acts, processes, operations, steps or functions disclosed in the specification or claims are not to be construed to be limited in a specific order, unless explicitly or implicitly described otherwise. In some examples a described act, function, process, operation, or step may include or may be broken into multiple subordinate acts, functions, processes, operations and/or steps.

Reference numerals are given to aid in understanding and are not intended to be limiting. It will be understood that when a feature is referred to as being “connected” or “coupled” to another element, the features may be directly connected, or coupled via one or more intervening elements.

Herein, a trailing “(s)” or “(es)” indicates an optional plurality. Thus, for example, “processor(s)” means “one or more processor,” “at least one processor,” or “a processor and optionally more processors.” Herein a slash “/” indicates “and/or” which conveys “‘and’ or ‘or’”. Thus “A/B” means “A and/or B;” equivalently, “A/B” means “at least one of A and B.”

Herein, simulated vocalizations may be in the form of vibrations transmitted from the body simulator from the head and neck region and may include audio. Simulated vocalizations may include vibrations, speech, and/or speech motion. Speech motion may include vibrations transmitted through the body simulator; for example, speech motion can be distinct from audio which is transmitted away from the body simulator through the air.

Herein “vocalization” (as in vocalization of a subject, vocalization simulator, and/or voice box) may include audio and/or haptic components, such as speech, speech motion, and/or vibrations.

Herein, a subject may be a person, e.g. a remote user. Any system and/or body simulator described herein may include a heartbeat simulator and heartbeat sensor(s) for providing heartbeat data and/or a heartbeat component of a signal received by the body simulator for simulation of a heartbeat of a subject (e.g. a remote user) by the body simulator. Herein vocalization data may be determined from at least one microphone.

The description and drawings are for illustration. The description is to aid the reader's understanding of the subject matter defined in the appended claims.

A nonlimiting list of reference numerals, for convenience, follows.

| | |
|---|---|
| body simulator | 100 |
| body simulator | 101 |
| body | 110 |
| chest region | 114 |
| head and neck region | 118 |
| speech simulator | 120 |
| heart simulator | 130 |
| receiver | 140 |
| breathing simulator | 170 |
| device | 200 |
| device | 201 |
| transmitter | 210 |
| sensors | 220 |
| breathing data | 242 |
| speech sensor data | 244 |
| processor | 250 |
| method | 300 |
| determine vocalization data | 310 |
| transmit | 320 |
| receive | 330 |
| simulate breathing | 340 |
| modulate | 350 |
| system | 400 |
| signal | 450 |
| breathing component | 452 |
| speaking component | 454 |

1. A body simulator, comprising:
a receiver configured to receive a signal based on sensor data including vocalization data from a subject; and
a body which includes:
a breathing simulator configured to simulate the breathing of the subject; and
a vocalization simulator configured to simulate the vocalization of the subject;
wherein the body simulator is configured to modulate the simulated breathing based on the vocalization data.

2. The body simulator of claim 1, wherein
the body simulator is configured to intermittently synchronize the simulated breathing
and the simulated vocalization.

3. The body simulator of claim 1, wherein
the simulated breathing is based on a breath component of the signal, and
the simulated breathing is based on a vocalization component of the signal.

4. The body simulator of claim 1, wherein
the body simulator is configured such that:
the simulated breathing of the subject is generated in real-time, and
the simulated vocalization of the subject is generated in real-time.

5. The body simulator of claim 1, wherein
the body simulator is configured such that:
the simulated breathing includes a periodic component and a modulation.

6. The body simulator of claim 1, wherein
the body simulator is configured such that:
the modulation is based on a vocalization component of the received signal.

7. The body simulator of claim 1, wherein
the body simulator is configured such that:
the modulation is an intermittent modulation.

8. The body simulator of claim 1, wherein
the body simulator is configured such that:
the modulation is at least one of: a phase shift, a delay, a positive pulse superimposed on the simulated breathing, a negative pulse superimposed on the simulated breathing, an increase in amplitude, or a decrease in amplitude.

9. The body simulator of claim 1, wherein
the body simulator is configured such that:
the modulation is determined by a machine learning algorithm.

10. The body simulator of claim 9, wherein
the body simulator is configured such that:
the simulated breathing is determined by the machine learning algorithm.

11. The body simulator of claim 10, wherein
the machine learning algorithm is configured to predict a beginning of an utterance or a speech break.

12. The body simulator of claim 1, wherein
the body includes:
a chest region, and
a head and neck region; and wherein
the breathing simulator is at the chest region, and wherein
the vocalization simulator is at the head and neck region.

13. A device, comprising:
at least one sensor for acquiring breathing data and vocalization data;
a transmitter for transmitting a signal including a breathing component and a vocalization component; wherein
the breathing component is based on the breathing data and is modulated based on the vocalization data.

14. A system for simulating a body of a subject, comprising:
at least one sensor for acquiring vocalization data;
a transmitter for transmitting a signal based on the vocalization data; and
a body simulator comprising:
a receiver configured to receive the signal, and
a breathing simulator configured to simulate the breathing of the subject;
wherein the system is configured to modulate the simulated breathing based on the vocalization data.

15. A method for simulating a body, comprising:
determining vocalization data from at least one sensor;
transmitting a signal based on the vocalization data;
receiving the signal at a body simulator;
simulating breathing;
simulating vocalization based on the vocalization data; and
modulating the simulated breathing based on the vocalization data.
